(19) United States
(12) Patent Application Publication
(10) Pub. No.: US 2012/0249115 A1
(43) Pub. Date: Oct. 4, 2012

(54) BANDGAP REFERENCE CIRCUIT

(76) Inventors: Wen-Hsien Chuang, Taichung City (TW); Ting-Hao Wang, Keelung City (TW); Yu-Tsung Lu, Hsinchu County (TW)

(21) Appl. No.: 13/191,458

(22) Filed: Jul. 27, 2011

(30) Foreign Application Priority Data
Mar. 30, 2011 (TW) 100110954

(51) Int. Cl. G05F 3/16

(52) U.S. Cl. 323/313

(57) ABSTRACT

A bandgap reference circuit includes a modulator, an amplifier, a demodulator, a closed feedback loop and an output circuit. The modulator is utilized for modulating an input signal to generate a modulated input signal. The amplifier is utilized for amplifying the modulated input signal to generate an amplified modulated input signal. The demodulator is utilized for demodulating the amplified modulated input signal to generate a demodulated signal. The closed feedback loop is coupled between an output terminal of the demodulator and an input terminal of the modulator. The output circuit is utilized for generating an output current according to the demodulated signal, where the output current is a constant current insensitive to fluctuations in temperature.

### BACKGROUND OF THE INVENTION

1. Field of the Invention

The present invention relates to a bandgap reference circuit, and more particularly, to a bandgap reference circuit that can generate a constant current which is insensitive to fluctuations in temperature.

2. Description of the Prior Art

Please refer to FIG. 1. FIG. 1 is a diagram illustrating a prior art bandgap reference circuit 100 (Curvature-Compensated BiCMOS Bandgap with 1-V Supply Voltage, IEEE JOURNAL OF SOLID-STATE CIRCUITS, VOL. 36, No. 7, JULY 2001). As shown in FIG. 1, the bandgap reference circuit 100 includes an amplifier 110, transistors M1-M3 and Q1 and Q2, and resistors R and R3. Because two input terminals of the amplifier 110 are virtual ground, voltages at the two input terminals are substantially the same (i.e., V+=V−). Therefore, further referring to the following formulae:

V_{EB1}=V_{EB2}+I_{Q2}*R₃;

I_{Q2}=(V_{T}*In(n))/R₃=I_{Q1};

the output current Iₒᵤₜ can be derived as follows:

Iₒᵤₜ=I₁=I_{Q1}+(V_{EB1}/R)=(V_{T}*In(n))/R₃+(V_{EB1}/R),

where V_{EB1} and V_{EB2} are emitter-base voltages of the transistors Q1 and Q2, respectively, I_{Q1} and I_{Q2} are currents of the transistors Q1 and Q2, respectively, V_{T} is the thermal voltage, and n is a ratio of a cross-sectional area of the transistor Q2 with respect to that of the transistor Q1.

In light of the above, because the value (V_{T}*In(n))/R₃ is positively correlated to temperature and the value (V_{EB1}/R) is negatively correlated to temperature, the output current Iₒᵤₜ is, ideally, constant with temperature.

In practice, however, because of imperfections such as unavoidable mismatches present in the amplifier 110, an input offset voltage V_{OS} arises. The above formula for the output current Iₒᵤₜ therefore becomes:

Iₒᵤₜ=(V_{T}*ln(n)±Vos)/R₃+(V_{EB1}/R).

Referring to the above formula, the output current lₒᵤₜ may not be constant with temperature due to the offset voltage V_{OS}.

In addition, please refer to FIG. 2. FIG. 2 is a diagram illustrating a prior art bandgap reference circuit 200 (U.S. Pat. No. 6,462,612). As shown in FIG. 2, the bandgap reference circuit 200 includes diodes D₁ and D₂, resistors R₁-R₃, a modulator 210, an amplifier 220, a demodulator 230, a low-pass filter 240, and a closed feedback loop coupled between an output terminal of the demodulator 230 and an input terminal of the modulator 210. The bandgap reference circuit 200 can cancel the offset voltage V_{OS} generated by the unavoidable mismatches of the amplifier 220, and generate a constant voltage V_{OUT} that is insensitive to fluctuations in temperature. Because the voltage V_{OUT} generated from the bandgap reference circuit 200 is constant with temperature, however, a current generated by the voltage V_{OUT} will not be constant with temperature, as characteristics of the transistor used to generate the current by the constant voltage V_{OUT} are influenced by temperature.

### SUMMARY OF THE INVENTION

It is therefore an objective of the present invention to provide a bandgap reference circuit, which can generate a constant current that is insensitive to fluctuations in temperature, in order to solve the above-mentioned problems.

According to one embodiment of the present invention, a bandgap reference circuit comprises a modulator, an amplifier, a demodulator, a closed feedback loop and an output circuit. The modulator is utilized for modulating an input signal to generate a modulated input signal. The amplifier is utilized for amplifying the modulated input signal to generate an amplified modulated input signal. The demodulator is utilized for demodulating the amplified modulated input signal to generate a demodulated signal. The closed feedback loop is coupled between an output terminal of the demodulator and an input terminal of the modulator. The output circuit is utilized for generating an output current according to the demodulated signal, wherein the output current is a constant current that is insensitive to fluctuations in temperature.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art bandgap reference circuit.

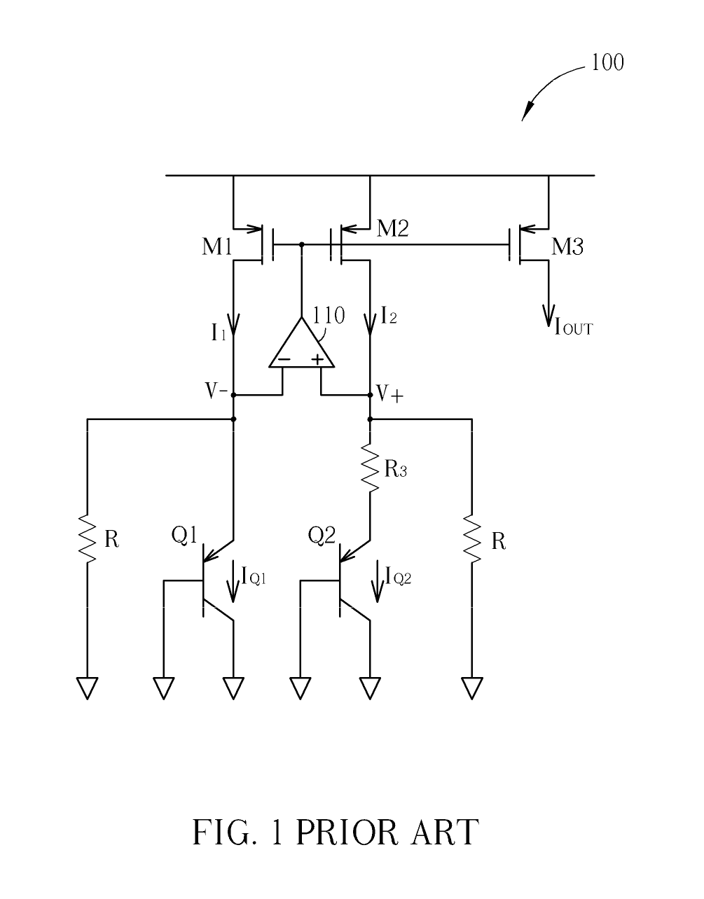

FIG. 2 is a diagram illustrating a prior art bandgap reference circuit.

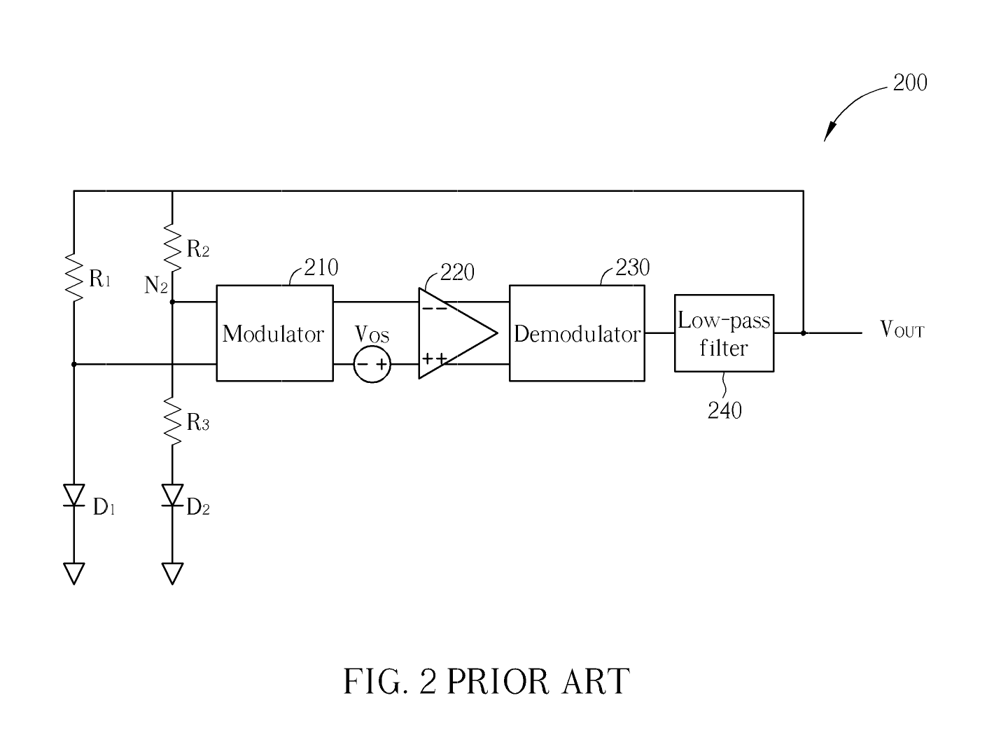

FIG. 3 is a diagram illustrating a bandgap reference circuit according to one embodiment of the present invention.

### DETAILED DESCRIPTION

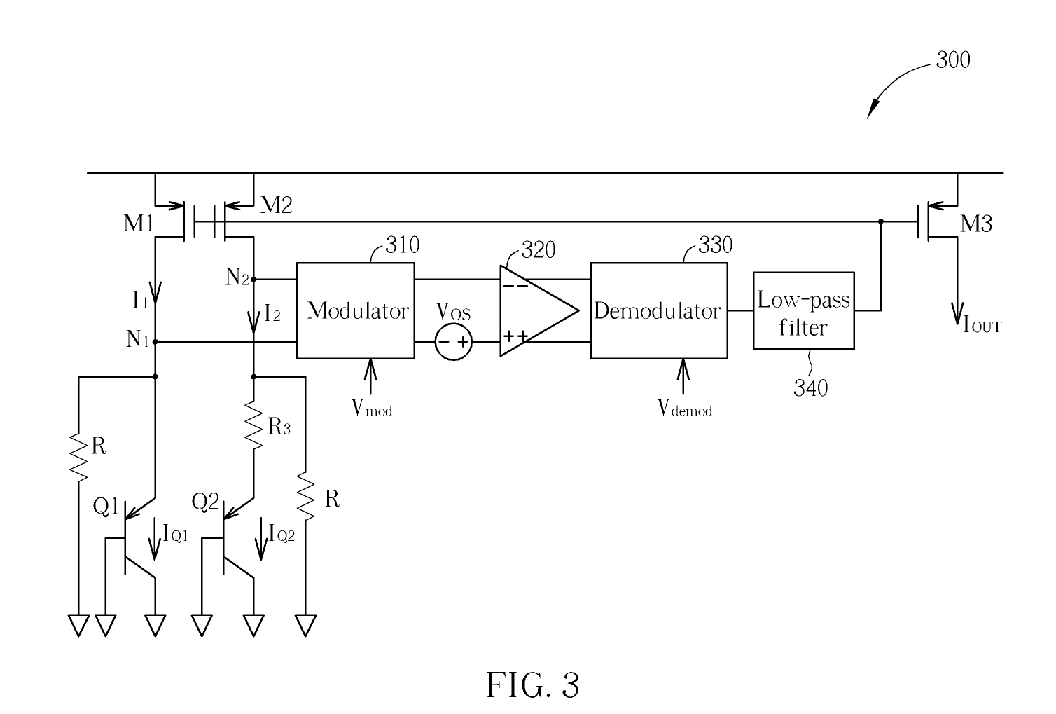

Please refer to FIG. 3. FIG. 3 is a diagram illustrating a bandgap reference circuit 300 according to one embodiment of the present invention. As shown in FIG. 3, the bandgap reference circuit 300 includes transistors M1-M3 and Q1 and Q2, resistors R and R₃, a modulator 310, an amplifier 320, a demodulator 330, a low-pass filter 340, and a closed feedback loop coupled between an output terminal of the demodulator 330 (or an output terminal of the low-pass filter 340) and an input terminal of the modulator 310, where an offset voltage V_{OS} exists between the two input terminals of the amplifier 320, and the transistor M3 serves as an output circuit to generate a constant current.

In addition, the P-N cross-sectional area of the transistor Q2 is different from that of the transistor Q1. In one embodiment of the present invention, the P-N cross-sectional area of the transistor Q2 is a multiple of the P-N cross-sectional area of the transistor Q1.

In the operations of the bandgap reference circuit 300, the modulator 310 receives a differential input signal from the nodes N₁ and N₂, and modulates the differential input signal to generate a modulated input signal, where a modulation signal V_{mod} used to modulate the differential input signal can be a periodic square wave, a periodic sinusoidal signal or any other appropriate modulation signal. During the modulation process, the modulator 310 acts to transform the slowly varying differential input signal to a higher frequency region within the signal spectrum.

The amplifier 310 then amplifies the modulated input signal to generate an amplified modulated input signal, where the amplified modulated input signal contains a component of the offset voltage V_{OS} of the amplifier 320.

The demodulator 330 then demodulates the amplified modulated input signal to generate a demodulated signal, where a demodulation signal V_{demod} used to demodulate the amplified modulated input signal can be a periodic square wave, a periodic sinusoidal signal or any other appropriate modulation signal. In one embodiment, the demodulation signal V_{demod} is the same as the modulation signal V_{mod}. In addition, during the demodulation process, the portion of the amplified modulated input signal related to the offset voltage V_{OS} is translated up in frequency, and the portion of the amplified modulated input signal related to the original differential input signal is modulated to be in the original frequency region.

The low-pass filter 340 filters the demodulated signal to generate a filtered demodulated signal. In the filtering process, because the portion of the demodulated signal related to the offset voltage V_{OS} is shifted to the high frequency region, the portion of the demodulated signal related to the offset voltage V_{OS} is removed. That is, the filtered demodulated signal merely includes the portion related to the original differential input signal.

In light of the above, after being processed by the modulator 310, the amplifier 320, the demodulator 330 and the low-pass filter 340, the differential input signal generated from the nodes N₁ and N₂ is merely amplified without being influenced by the offset voltage V_{OS}.

For the whole operations of the bandgap reference circuit 300, because two input terminals of the amplifier 320 are virtual ground, voltages at the nodes N₁ and N₂ are substantially the same, and further referring to the following formulae:

V_{EB1}=V_{EB2}+I_{Q2}*R₃;

I_{Q2}=(V_{T}*ln(n))/R₃=I_{Q1},

the output current Iₒᵤₜ can be derived as follows:

Iₒᵤₜ=I₁=I_{Q1}+(V_{EB1}/R)=(V_{T}*ln(n))/R₃+(V_{EB1}/R),

where V_{EB1} and V_{EB2} are emitter-base voltages of the transistors Q1 and Q2, respectively, I_{Q1} and I_{Q2} are currents of the transistors Q1 and Q2, respectively, V_{T} is the thermal voltage, and n is a ratio of the cross-sectional area of the transistor Q2 with respect to that of the transistor Q1.

Because the influence of the offset voltage V_{OS} of the amplifier 320 has been removed, the output current Iₒᵤₜ of the bandgap reference circuit 300 is a constant current that is insensitive to fluctuations in temperature, and is stabilized by the actions of the modulator 310, the amplifier 320, the demodulator 330 and the components arranged on the closed feedback loop.

Briefly summarized, in the bandgap reference circuit of the present invention, the offset voltage of the amplifier can be removed by using the modulator, demodulator and filter, and the output current generated from the bandgap reference circuit is a constant current that is insensitive to fluctuations in temperature.

Those skilled in the art will readily observe that numerous modifications and alterations of the device and method may be made while retaining the teachings of the invention.

What is claimed is:

1. A bandgap reference circuit, comprising:
a modulator, for modulating an input signal to generate a modulated input signal;
an amplifier, coupled to the modulator, for amplifying the modulated input signal to generate an amplified modulated input signal;
a demodulator, coupled to the amplifier, for demodulating the amplified modulated input signal to generate a demodulated signal;
a closed feedback loop, coupled between an output terminal of the demodulator and an input terminal of the modulator; and
an output circuit, coupled to the output terminal of the demodulator, for generating an output current according to the demodulated signal, wherein the output current is insensitive to fluctuations in temperature, and is stabilized by actions of the modulator, the amplifier, the demodulator and the closed feedback loop.

2. The bandgap reference circuit of claim 1, further comprising:
a low-pass filter, coupled to the output terminal of the demodulator, for filtering the demodulated signal to generate a filtered demodulated signal;
wherein the closed feedback loop is coupled between an output terminal of the low-pass filter and the input terminal of the modulator, the output circuit is coupled to the output terminal of the low-pass filter, and the output circuit generates the output current according to the filtered demodulated signal.

3. The bandgap reference circuit of claim 1, wherein the input signal is a differential input signal.

4. The bandgap reference circuit of claim 3, wherein the input terminal of the modulator includes a first input node and a second input node, and the bandgap reference circuit further comprises:
a first transistor, coupled between a reference voltage and the first input node of the modulator; and
a second transistor, coupled between the reference voltage and the second input node of the modulator, wherein a P-N cross-sectional area of the first transistor is different from a P-N cross-sectional area of the second transistor.

5. The bandgap reference circuit of claim 4, further comprising:
a third transistor, wherein a source electrode or a drain electrode of the third transistor is coupled to the first input node of the modulator; and
a fourth transistor, wherein a source electrode or a drain electrode of the fourth transistor is coupled to the second input node of the modulator; and
the output circuit comprises:
a fifth transistor;
wherein gate electrodes of the third transistor, the fourth transistor and the fifth transistor are coupled to the output terminal of the demodulator.

6. The bandgap reference circuit of claim 5, further comprising:
a low-pass filter, coupled to the output terminal of the demodulator, for filtering the demodulated signal to generate a filtered demodulated signal;
wherein the closed feedback loop is coupled between an output terminal of the low-pass filter and the input terminal of the modulator, the output circuit is coupled to the output terminal of the low-pass filter, the output circuit generates the output current according to the filtered demodulated signal, and the gate electrodes of the third transistor, the fourth transistor and the fifth transistor are coupled to the output terminal of the low-pass filter.
